(19) United States
(12) Patent Application Publication
(10) Pub. No.: US 2004/0065541 A1
(43) Pub. Date: Apr. 8, 2004

(54) Stepped voltage controller for ceramic oxygen generating systems

(75) Inventor: Scott R. Sehlin, Bettendorf, IA (US)

Correspondence Address: MARSTELLER & ASSOCIATES, P.C., PO BOX 803302, DALLAS, TX, 75380-3302, US

(73) Assignee: Litton Systems, Inc., Los Angeles, CA (US)

(21) Appl. No.: 10/065,939

(22) Filed: Dec. 2, 2002

Related U.S. Application Data
(60) Provisional application No. 60/319,503, filed on Aug. 27, 2002.

(51) Int. Cl. B23H 3/02; C25B 9/00

(52) U.S. Cl. 204/228.1; 204/279

(57) ABSTRACT

A power supply (S) for a gas generating system (G) of the type including a barrier system (10) permeable to selected charged particles (12) flowing from a first side (14) to a second side (16) includes a direct current (DC) power source (18) in an electrical power circuit (20) connected across the first and second sides of the permeable barrier system (10). A plurality of resistive elements (22) are parallel connectable in the electrical circuit (20). Switches (24) selectively connect a desired resistive element (22) between the power source (18) and barrier system (10). A controller (26) activates certain switches (24) to connect a corresponding resistor (22) in the circuit (10) to controllably vary the flow of charged particles across the permeable barrier (10).

### CROSS REFERENCE TO RELATED APPLICATIONS

This application claims the benefit of U.S. Provisional Application Serial No. 60/319,503, filed Aug. 27, 2002, entitled STEPPED VOLTAGE CONTROLLER FOR CERAMIC OXYGEN GENERATING SYSTEMS, the disclosure of which is hereby incorporated by reference herein in its entirety.

### BACKGROUND OF INVENTION

1. Technical Field

The invention relates to the field of ceramic oxygen generating systems (COGS) and more particularly relating to power supplies and controller for such ceramic oxygen generating systems.

2. Background Art

The core ceramic electrolyte in a ceramic oxygen generating system (COGS) requires a voltage source of a constant polarity (i.e. not AC). For a given electrolyte the rate of oxygen output is measured by the current, which depends on the applied voltage, as well as on other system parameters such as oxygen partial pressure of the inlet air and the electrolyte temperature. To adjust the oxygen output in a ceramic oxygen generating system, adjustment of one of the aforementioned parameters in required. Of these parameters, adjusting the applied voltage is generally preferred because the response time is nearly instantaneous (<0.01 sec).

For commercial applications, the expense of a variable voltage DC power supply can be prohibitive. An alternative method is described by Phillips, et al. in U.S. Pat. No. 5,855,672. The electrical current is switched on and off, varying the proportion of current on time based on a feedback signal. The variation of current on time yields a variable time averaged oxygen output. When a storage plenum is inserted between the ceramic electrolyte and the oxygen output port and the pressure is monitored, a variable continuous output can be achieved, replenished by the on-off switching according to the usage rate.

Many commercial applications also call for extended product lifetimes, sometimes in excess of 20,000 hours. During early life testing of Integrated Manifold and Tube (IMAT) or ceramic oxygen generating modules, a strong correlation has been noted between long life and low drive voltages. Applying voltage to modules using full-wave rectified AC as a low cost power source dramatically increased the rate of migration of silver across the electrical isolations that are an integral part of an electrical interconnection system as compared to a DC applied voltage equivalent to the RMS value of the rectified AC voltage. Based on studies using steady DC drive voltages, it has been found that minimizing the peak voltage input to the module is desirable for long COGS product life.

While the above cited references introduce and disclose a number of noteworthy advances and technological improvements within the art, none completely fulfills the specific objectives achieved by this invention.

### SUMMARY OF INVENTION

In accordance with the present invention, a power supply for a gas generating system of the type that includes a barrier system permeable to selected charged particles flowing from a first side to a second side includes a direct current (DC) power source that is in an electrical power circuit connected across the first and second sides of the permeable barrier system. A plurality of resistive elements each having a fixed ohmic resistance are connectable in parallel electrical paths in the electrical power circuit. Resistor switches selectively connect a specific resistive element in the electrical power circuit between the DC power source and barrier system. A controller responsively controls the connection of at least one resistive element into and out of the electrical power circuit such that the controller affects a varying flow of charged particles across the permeable barrier.

These and other objects, advantages and features of this invention will be apparent from the following description taken with reference to the accompanying drawings, wherein is shown the preferred embodiments of the invention.

### BRIEF DESCRIPTION OF DRAWINGS

A more particular description of the invention briefly summarized above is available from the exemplary embodiments illustrated in the drawing and discussed in further detail below. Through this reference, it can be seen how the above cited features, as well as others that will become apparent, are obtained and can be understood in detail. The drawings nevertheless illustrate only typical, preferred embodiments of the invention and are not to be considered limiting of its scope as the invention may admit to other equally effective embodiments.

FIG. 1 is a schematic diagram of the present voltage controller.

FIG. 2 is a chart showing the effect of Applied Voltage on IMAT Module Life.

FIG. 3 depicts a schematic of a portion of a known oxygen generating system utilizing an electrochemical-oxygen generator in the form of a modular ceramic oxygen generator.

### DETAILED DESCRIPTION

So that the manner in which the above recited features, advantages, and objects of the present invention are attained can be understood in detail, more particular description of the invention, briefly summarized above, may be had by reference to the embodiment thereof that is illustrated in the appended drawings. In all the drawings, identical numbers represent the same elements.

U.S. Pat. No. 5,985,113 issued on Nov. 16, 1999, U.S. Pat. No. 5,871,624 issued on Feb. 16, 1999, U.S. Pat. No. 6,352,624 issued on Mar. 5, 2002, and application Ser. No. 09/418,831 filed Oct. 15, 1999, now pending, all of which are incorporated herein in their entirety and assigned to the instant assignee, teach how an electrochemical oxygen generating device can be manufactured.

The present invention relates to a power supply (S) for a known electro-chemical gas generating system (G) to separate or concentrate a selected gas from a feedstock fluid or gas, and the gas generating system (G) of the type that includes a barrier system (10), such as a ceramic membrane, that is permeable to selected charged particles or ions (12) flowing from a first side (14) to a second side (16) of the membrane (10) includes a direct current (DC) power source (18) that is in an electrical power circuit (20) connected across the first and second sides (14 and 16) of the permeable barrier system (10).

A plurality of resistive elements (22a, 22b, 22c) each having a fixed ohmic resistance are connectable in parallel electrical paths in the electrical power circuit (20). Resistor switches (24a, 24b, 24c) selectively connect a specific, corresponding resistive element (22a, 22b, 22c respectively) in the electrical power circuit (20) between the DC power source (18) and barrier system (10). A controller (26) electrically connected to the switches (24) responsively controls the electrical connection of at least one resistive element (22) into and out of the electrical power circuit (20) such that the controller (26) affects a varying flow of charged particles (12) across the permeable barrier or membrane (10).

The resistive elements (22) may be a known type of resistor, heater element, or other similar method to produce a resistance in an electrical circuit. Generally, such resistive elements produce waste energy during the application of an electrical current as the electrical current passes through the resistive elements (22). The waste energy or heat can optionally be used to preheat the feedstock fluid or located within the oven chamber or furnace component of the electro-chemical gas generating system for effective utilization of the waste energy.

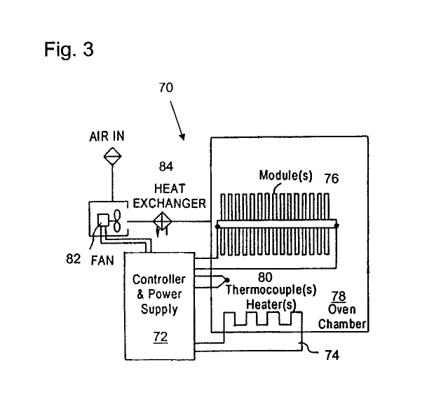

FIG. 3 illustrates a schematic of a portion of a known oxygen generating system (70) utilizing an electrochemical-oxygen generator in the form of a modular ceramic oxygen generator. This schematic depicts a power supply and controller (72), such as that of the present invention, which power supply and controller (72) supplies electrical power to an oven heater (74) to raise the temperature within the operating range of an oxygen-generating module assembly (76). The oxygen-generating module assembly (76) can include or more oxygen-generating modules such as those disclosed in U.S. Pat. No. 5,871,624 and U.S. Pat. No. 5,985,113.

The oxygen-generating modules (76) are positioned in the oven chamber or furnace (78). After the oven chamber (78) reaches the minimum preferred operating temperature, as detected by at least one thermocouple (80) mounted in the oven chamber (76), the controller (72) begins to apply electrical power to a fan motor (82) to deliver oxygen-laden air through a counter-flow heat exchanger (84) into the oven (78) chamber to a module assembly including at least one module (76). The controller (72) also delivers electrical power to the modules (76), and oxygen is electrochemically generated, as taught in U.S. Pat. No. 5,871,624 and U.S. Pat. No. 5,985,113. Depending upon the amount of oxygen to be generated, the amount of electrical power can be varied.

As electrical power is delivered to the modules (76) and oxygen is generated, electrical resistance within the modules (76) generates additional heat. Also, heaters (74) that are mounted within the furnace (78) may be replaced by or augmented by the resistive elements (22) of the present invention that produce waste heat as a result or by-product of the electrical resistance phenomenon.

Thus the present invention is a method to enable lower peak IMAT or ceramic oxygen generating modules' drive voltages than is possible either with an on/off voltage source (as described by Phillips et al.), or with a rectified A.C. voltage source. The present method can be implemented using inexpensive components relative to a variable constant voltage or current source.

The maximum voltage will preferably be set to provide the maximum required oxygen or other gas output when the IMAT modules are driven continuously at the selected voltage. When lower oxygen output is required, the voltage will switch between the maximum value and one or more lower values at a predetermined cycle time. The proportion of maximum voltage versus lower voltage cycles will be based on an input signal (28) to the controller (26), such as the output of a pressure transducer from a storage plenum or a signal from a flow rate selector (possibly in combination with a flow meter signal).

By increasing the number of voltage steps to a number greater than two, it becomes possible to reduce the maximum voltage when the required oxygen output is less than that produced by continuous operation at one of the lower voltages. The number of voltage steps is achieved or determined by choosing the number of resistors (22) and corresponding switches (24) that will be installed in the gas generating system (G).

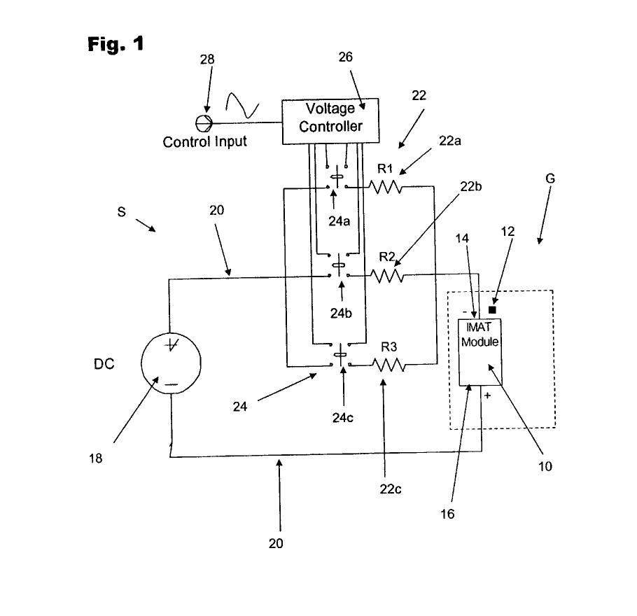

The specified voltage steps can be achieved simply and cost-effectively as shown in FIG. 1. In the preferred embodiment, one of the resistances, R1 is zero or nearly zero, assuming that the DC power supply is designed to provide approximately the maximum required voltage for the application. Resistance values R2, and R3 are preferably larger than R1, causing some of the power supply voltage to be dissipated across the resistors instead of the IMAT modules when the output is directed through those resistors by the opening and closing of appropriate relays in series with each resistive element.

The controller (26) may optionally actuate multiple switches in order to increase the effective resistance in the circuit or the number of possible voltage steps offered the user of the oxygen generating system.

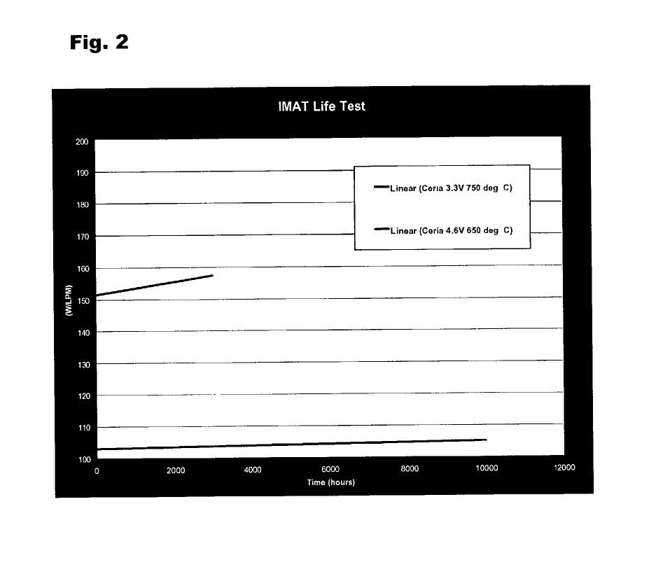

FIG. 2 is a chart showing the effect of Applied Voltage on IMAT Module Life using the circuitry of the present invention.

The foregoing disclosure and description of the invention are illustrative and explanatory thereof, and various changes in the size, shape and materials, as well as in the details of the illustrated construction may be made without departing from the spirit of the invention.

1. A power supply for a gas generating system of the type including a barrier system permeable to selected charged particles flowing from a first side to a second side, the invention comprising:
a direct current (DC) power source in an electrical power circuit connected across the first and second sides of the permeable barrier system;
a plurality of resistive elements each having a fixed ohmic resistance, and each connectable in parallel electrical paths in the electrical power circuit;
resistor switch means for selectively connecting a desired resistive element in the electrical power circuit between the DC power source and barrier system; and
control means for controlling the connection of at least one resistive element in the electrical power circuit;
whereby the controller controllably affects a varying flow of charged particles across the permeable barrier.

2. The invention of claim [Claim Reference] wherein the permeable barrier system is a component of a ceramic oxygen generating system (COGS).

3. An electro-chemical gas generating system for concentrating a selected gas from a feedstock fluid of the type including a ceramic membrane system permeable to selected charged particles flowing from a first side to a second side, the invention comprising:
a direct current (DC) power source in an electrical power circuit connected across the first and second sides of the ceramic membrane system;
a plurality of resistive elements each having a fixed ohmic resistance, and each connectable in parallel electrical paths in the electrical power circuit;
resistor switch means for selectively connecting a desired resistive element in the electrical power circuit between the DC power source and ceramic membrane system; and
control means for controlling the connection of at least one resistive element in the electrical power circuit;
whereby the controller controllably affects a varying flow of charged particles across the ceramic membrane.

4. The invention of claim [Claim Reference] wherein the resistive element is a resistor.

5. The invention of claim [Claim Reference] wherein the resistive element generates waste energy in the form of heat.

6. The invention of claim [Claim Reference] wherein the waste energy is used to preheat the fluid used as a feedstock for the gas generating system.

7. The invention of claim [Claim Reference] wherein the resistive element is mounted within an oven chamber for the gas generating system.
